(19) United States
(12) Patent Application Publication
(10) Pub. No.: US 2017/0257694 A1
(43) Pub. Date: Sep. 7, 2017

(54) System and Method for Rapid Scan and Three Dimensional Print of External Ear Canal

(71) Applicant: BRAGI GmbH, Munchen (DE)

(72) Inventor: Peter Vincent Boesen, München (DE)

(21) Appl. No.: 15/447,465

(22) Filed: Mar. 2, 2017

Related U.S. Application Data
(60) Provisional application No. 62/302,267, filed on Mar. 2, 2016.

(51) Int. Cl. H04R 1/10; B33Y 80/00; B33Y 50/02; B29C 67/00; B33Y 10/00

(52) U.S. Cl. CPC H04R 1/1058; B29C 67/0059; B29C 67/0088; B33Y 10/00; B33Y 50/02; B33Y 80/00; H04R 1/1016; H04R 1/1066; B29K 2083/00

(57) ABSTRACT

A method of custom fitting an earpiece to an ear of a user, is provided. The method includes collecting three-dimensional measurement data associated with the ear of the user using a scanning system, constructing a customized model for an ear piece sleeve using the three-dimensional data and earpiece data, and using a three dimensional printer to print an earpiece sleeve based on the customized model.

### PRIORITY STATEMENT

This application claims priority to U.S. Provisional Patent Application 62/302,267, filed on Mar. 2, 2016, and entitled System and Method for Rapid Scan and Three Dimensional Prim of External Ear Canal, hereby incorporated by reference in its entirety.

### FIELD THE INVENTION

The present invention relates to wearable devices. More particularly, but not exclusively, the present invention relates to ear pieces.

### BACKGROUND

Current methodologies for the creation of a custom sleeve for a ear worn device is cumbersome and complex. The system is also extremely time consuming and may create a foreign body in the ear canal if the injectable resin tears away from the remainder of the injected material. The skilled worker must typically first place a small sponge or other material to create a medial-most extent of the sleeve to be created. In most situations, this material is tied together by a string which itself is carried out of the user's ear canal and conchal region. Next, the skilled worker must use reasonable care while inserting the material which will be used to take the impression of the ear canal and conchal region. Pressure may be exerted which could be perceived as uncomfortable by the recipient. Temperatures may also be perceived as uncomfortable by the user. Next, after allowing the impression material to become firm, the string is typically grasped and the material removed from the ear and ear canal of the user. The canal/concha impression is then sent where the sleeve is created from this impression. This takes a great deal of time. It is also quite expensive and must further be performed by people with reasonable skill and training.

What is needed is a new system and method designed to allow for the three dimensional placement of an earpiece into a segmentally designated area of a sleeve which solves the problems in the art identified above.

### SUMMARY

Therefore, it is a primary object, feature, or advantage of the present invention to improve over the state of the art.

It is a further object, feature, or advantage of the present invention to provide a point of service creation of a custom fit mold expressly designed for the sleeving of an earpiece designed to be worn at/in the external auditory canal.

Another object, feature, or advantage is to use of a three dimensional printer or other rapid manufacturing equipment at the point of service to take the data captured in the laser measurement device and rapidly create a biomedical sleeve of a substance such as silicone.

Yet another object, feature., or advantage is to avoid costly delays due to present day requirements for remote lab creation of the custom sleeve.

A still further object, feature, or advantage is to create a CAD compliant sleeve for exact fitting to the earpiece device in question.

Another object, feature, or advantage is the ability to add sensors to the CAD compliant sleeve attached to the earpiece.

Yet another object, feature, or advantage is the ability to extend the sensor or sensor arrays of the earpiece to the CAD compliant sleeve.

One or more of these and/or other objects, features, or advantages of the present invention will become apparent from the specification and claims that follow. No single embodiment need provide each and every object feature, or advantage. Different embodiments may have different objects, features, or advantages. Therefore, the present invention is not to be limited to or by an objects, features, or advantages stated herein.

According to one aspect, a method, apparatus, and system for the rapid creation and fitting of an ear worn device is provided. First, the user would be seated comfortably in a chair and positioned for insertion of a laser probe into the external canal of the ear to be measured. The laser systems are well known in the art such as the GN Otometrics Otoscan (see the earscanning.com web site). However, current systems require the data to be transferred to a remote facility where the actual mold is created. The system may use a three dimensional printer operatively connected to the scanning system. Such a system would be pre-loaded with the specific spatial requirements for fitting to the earpiece. Conformation of the positional requirements of the device to the mold would be rectified at this time. A biomaterial such as silicone would be utilized to provide an individualized fit for each individual. Such a custom made sleeve may be formulated and completed within minutes at the point of scanning of the ear/ear canal of the user. The completed sleeve would optionally be created with extension sensors of the earpiece requiring even closer contact to the surface to be monitored. The sleeve may be fitted with the earpiece device and inserted into the external auditory canal of the user without the need or requirement of remote creation of the sleeve. This facilitates the rapid deployment and monitoring of the user in order to provide unparalleled speed and accuracy of fitting while also allowing for the simultaneous extension of monitoring sensor arrays.

According to another aspect, a method of custom fitting an earpiece to an ear of a user is provided. The method includes collecting three-dimensional measurement data associated with the ear of the user using a scanning system, constructing a customized model for an ear piece sleeve using the three-dimensional data and earpiece data, and using a three dimensional printer to prim an earpiece sleeve based on the customized model. The earpiece may be formed from one or more biocompatible materials such as silicone. The customized model may include placement of one or more sensors of the earpiece sleeve. The method may further include integrating the one or more sensors into the earpiece sleeve based on the customized model. The method may further include installing the earpiece sleeve on the earpiece. The method may further include placing the earpiece with the earpiece sleeve within the ear of the user and testing fit of the earpiece with the earpiece sleeve. The method may be performed on site in a single visit by the user, The method may be repeated for a right ear of the user and a left ear of the user.

### BRIEF DESCRIPTION OF THE DRAWINGS

FIG. 1 is an overview of one example of the present invention.

FIG. 2 is a block diagram illustrating components of one example of an earpiece with one or more sensors which may be placed on a sleeve.

FIG. 3 illustrates one example oft method.

A method, apparatus, and system for the rapid creation and fitting of an ear worn device is provided. First, the user would be seated comfortably in a chair and positioned for insertion of a laser probe into the external canal of the ear to be measured. The laser systems are well known in the an such as the GN Otometrics Otoscan (available at the web site earscanning.com). However, current systems require the data to be transferred to a remote facility where the actual mold is created. The system may use a three dimensional printer operatively connected to the scanning system. Such a system would be pre-loaded with the specific spatial requirements for fitting to the earpiece. Conformation of the positional requirements of the device to the mold would be rectified at this time. A biomaterial such as silicone would be utilized to provide an individualized fit for each individual. Such a custom made sleeve may be formulated and completed within minutes at the point of scanning of the ear/ear canal of the user. The completed sleeve would optionally be created with extension sensors of the earpiece requiring even closer contact to the surface to be monitored. The sleeve may be fined with the earpiece device and inserted into the external auditory canal of the user without the need or requirement of remote creation of the sleeve. This facilitates the rapid deployment and monitoring of the user in order to provide unparalleled speed and accuracy of fitting while also allowing for the simultaneous extension of monitoring sensor arrays.

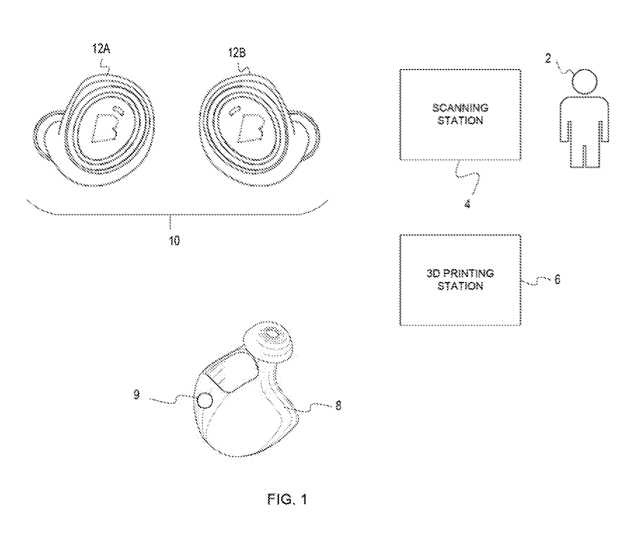

FIG. 1 illustrates an overview of one aspect. A pair of earpieces 10 are shown which includes a left ear piece 12A and a right ear piece 12B. The earpieces preferably provide for wireless communications an may include speakers, wireless transceivers and possibly one or more microphones and one or more additional sensors. A scanning station 4 is shown. The scanning station may be a laser scanning station and use a laser system such as is available from GN Otometrics Otoscan (available at the web site earscanning.com). The scanning station provides for scanning the external auditory canal of an individual 2. The individual may be seated during a scanning session. The scanning station collects three-dimensional measurement data associated with the ear of the user. A 3D printing station 6 is also shown. The 3D printing station 6 may include a 3D printer for printing a sleeve for an earpiece. An example of a sleeve 8 is shown. A sensor 9 may be positioned on the sleeve 8. It should be appreciated that one or multiple sensors may be positioned on the sleeve at any number of different locations on the sleeve. The sensor may be of any number of different kinds of sensors including a contact sensor, a temperature sensor or other physiological sensor, or otherwise. Where sensors are positioned on the sleeves, electrical connections from the sensors may be interfaced directly to connectors on the earpieces or alternatively conductors or cabling may be run from the one or more sensors to a connector on the earpiece, or conductive traces may be printed on the sleeve and run from the sensor to contacts or connectors of the earpiece.

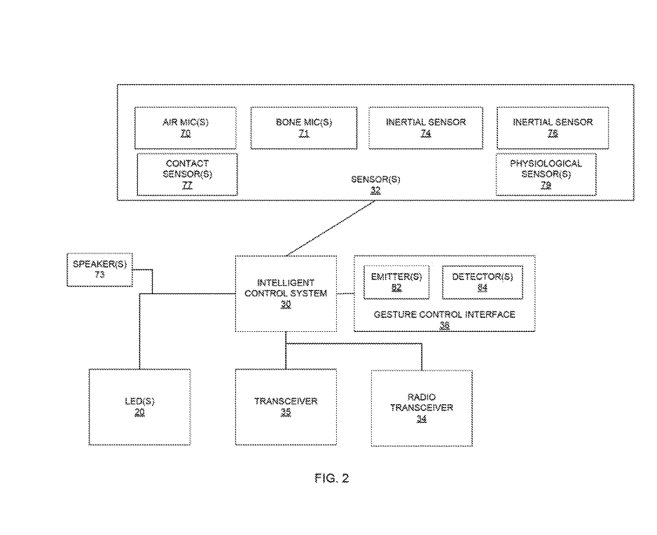

FIG. 2 is a block diagram of one example of an earpiece. As shown in FIG. 2, a plurality of sensors 32 are shown. The sensors may include one or more microphones such as an air microphone 70, a bone microphone 71, an inertial sensor 74, a second inertial sensor 76, and one or more contact sensors 77. The contact sensors 77 may be used to sense information useful in determining whether or not the earpiece is properly positioned within the ear of a user. One or more physiological sensors 79 may also be present such as a temperature sensor, a pulse oximeter, or other type of physiological sensor. Although various sensors are shown and described it is contemplated that any number of other sensors may be included as may be appropriate for a particular application. In addition, as previously explained, one or more of the sensors 32 may be positioned at or on an ear sleeve. The sensors 32 are operatively connected to an intelligent control system 30 which may include one or more processors. The intelligent control system 30 may also be operatively connected to a gesture control interface 36 which may include one or more emitters 82 and detectors 84 used for receiving gestural input from a user. One or more speakers 73 may be present which are operatively connected to the intelligent control system 30. One or more light emitting diodes 20 may be present which are also operatively connected to the intelligent control system 30. One or more transceivers may be present such as a. short range transceiver 35 which may be a NFMI transceiver used to connect one earpiece with another earpiece. A radio transceiver 34 may be a wireless transceiver such as a Bluetooth transceiver, a Wi-Fi transceiver, Li-Fi transceiver or other type of wireless transceiver. The radio transceiver 34 allows the earpiece to connect with other devices such as mobile devices such as cell phones and tablets or other types of computing devices.

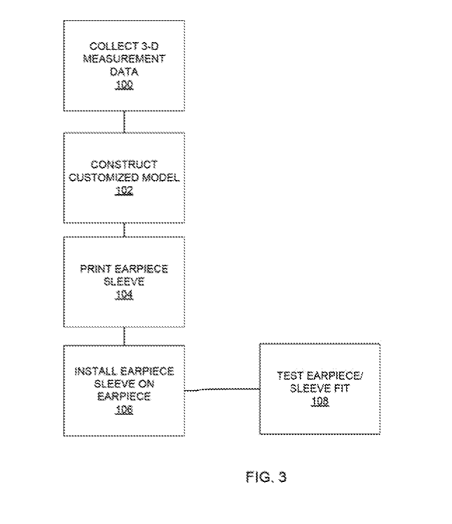

FIG. 3 illustrates one example of a method. In step 100 three dimensional measurement data is collected. This may include sitting a user comfortably in a chair so as to position one or both ears of the user for insertion of a laser probe into the external canal of the ear to be measured. Either one ear may be done at a time or both ears may be scanned at the same time. Instead of laser scanning other types of scanning technologies may be used, photogrammetry, or other measurement methods.

Next in step 102 a customized model is constructed. The model may be constructed in various formats. In one embodiment, the model may be constructed as a computer aided drafting (CAD) model. For example, the CAD model may be in the STL (STereoLithography) file format or other format.

Next in step 104 the earpiece sleeve may be printed. The earpiece sleeve may be printed using a 3D printer although other types of rapid manufacturing techniques may be used instead. Various types of biocompatible materials may be used. One type of material that may be used is silicone. In some embodiments, sensors may also be printed onto the earpiece sleeve, conductors for sensors may be printed onto the earpiece sleeve, or sensors may be attached to the earpiece sleeve manually or automatically.

Next, in step 106 the earpiece sleeve may be installed on the earpiece and in step 108 the earpiece and sleeve combination may be tested. This may include visual inspection. Testing may include placing the earpiece with fitted sleeve into the ear of the individual and testing its fit and its operation. Other types of testing may be performed. For example, if the sleeve includes one or more sensors then operations of each of the sensors may be performed. In addition, calibration of the one or more sensors may be performed with the earpiece and sleeve properly fitted to the ear of an individual.

The process shown in FIG. 3 may preferably be performed on-site and such that the process is sufficiently short in time that an individual may schedule a single appointment to have the measurements performed, the earpiece sleeves manufactured, fitted, and installed.

Therefore, various methods, system, and apparatus for custom fit earpieces have been shown and described. Numerous variations, options, and alternatives are contemplated including in the materials used, the sensors used, the manner in which measurements are acquired, the particulars of the model used, the 3D printer used to manufacture the sleeves, and other alternatives.

What is claimed is:

1. A method of custom fitting an earpiece to an ear of a user the method comprising:
collecting three-dimensional measurement data associated with the ear of the user using a scanning system;
constructing a customized model for an ear piece sleeve using the three-dimensional data and earpiece data; and
using a three dimensional printer to print an earpiece sleeve based on the customized model.

2. The method claim 1 wherein the earpiece sleeve is formed from a biocompatible material.

3. The method of claim 2 wherein the biocompatible material is silicone.

4. The method of claim 1 wherein the customized model includes placement of one or more sensors of the earpiece sleeve.

5. The method of claim 4 further comprising integrating the one or more sensors into the earpiece sleeve based on the customized model.

6. The method of claim 1 further comprising installing the earpiece sleeve on the earpiece.

7. The method of claim 6 further comprising placing the earpiece with the earpiece sleeve within the ear of the user and testing fit of the earpiece with the earpiece sleeve.

8. The method of claim 7 wherein the method is performed on site in a single visit by the user.

9. The method of claim 1 wherein the method is repeated for a right ear of the user and a left ear of the user.
